(19) United States
(12) Patent Application Publication
(10) Pub. No.: US 2017/0025106 A1
(43) Pub. Date: Jan. 26, 2017

(54) WRIST BAND PIANO

(71) Applicant: Salahattin Bucak, New York, NY (US)

(72) Inventor: Selahattin Bucak, New York, NY (US)

(21) Appl. No.: 15/134,481

(22) Filed: Apr. 21, 2016

Related U.S. Application Data
(60) Provisional application No. 62/178,872, filed on Apr. 21, 2015.

(51) Int. Cl. G10H 1/34; G10H 1/00; H04W 4/00

(52) U.S. Cl. CPC G10H 1/344; H04W 4/008; G10H 1/0008; G10H 2240/211; G10H 2220/326; G10H 2220/561; G10H 2230/065

(57) ABSTRACT

An electronic device capable of synthesizing one or more musical instruments. A plurality of sensors, which may be mounted on the hand of the user, provide signals to a control module indicating that a sensor has made contact with a surface. A control module receives signals and determines whether to play a sound. Exemplary sensors include pressure-sensitive resistors and dedicated motion-sensing integrated circuits, and are in communication with one or more integrated circuits in the control module over a communication link.

### PRIORITY CLAIM

This application claims priority to U.S. Patent Application No. 62/178,872, filed May 5, 2014 and titled, “WRIST BAND PIANO,” the contents of which is incorporated by reference in its entirety.

### BRIEF DESCRIPTION OF THE DRAWINGS

The features and advantages of the present disclosure will be more fully understood with reference to the following detailed description when taken in conjunction with the accompanying figures, wherein:

FIG. 1 is view of a preferred embodiment of the invention while in use.

FIG. 2 is an alternated view of a preferred embodiment of the invention.

FIG. 3 is a schematic drawing of a sensor glove for use with embodiments of the present invention.

FIG. 4 is drawing of a glove for use with embodiments of the present invention.

FIGS. 5a-5c are views of a housing for a control module for use with embodiments of the present invention.

FIG. 6 is a view of a wrist band for use with embodiments of the present invention.

### SUMMARY

In some embodiments, a portable music system may include at least one sensor glove in which a group of pressure-responsive sensors have been embedded, a control module, a communication link connecting the sensor glove to the control module, and/or a wrist band for securing the control module to a user.

In some embodiments, the control module may include a housing, speaker, power supply, and an integrated circuit. In some embodiments, the integrated circuit is configured to receive a signal from one the pressure-responsive sensors when the sensor is depressed and play a sound. In some embodiments, the pressure-responsive sensors are pressure-responsive resistors. In some embodiments, the pressure-responsive sensors are pressure-mechanical switches.

In some embodiments, the wrist band is formed from elastic material, leather, and silicone. In some embodiments, the control module is further configured to record the sounds generated for later playback. In some embodiments, the control module is capable of simulating a group of different musical instruments.

In some embodiments, a portable music system may include a group of pressure-responsive sensors, a control module, a communication link connecting the sensors to the control module, and/or a wrist band for securing the control module to the user. In some embodiments, the control module may include a housing, speaker, power supply, and an integrated circuit. In some embodiments, the integrated circuit is configured to receive a signal from one the pressure-responsive sensors when the sensor is depressed and play a sound. In some embodiments, the pressure-responsive sensors are pressure-responsive resistors. In some embodiments, the pressure-responsive sensors are pressure-mechanical switches.

In some embodiments, the wrist band is formed from elastic material, leather, and silicone.

In some embodiments, the control module is capable of simulating a group of different musical instruments. In some embodiments, the control module is further configured to record the sounds generated for later playback. In some embodiments, the communication link is a wireless connection between the control module and the sensors. In some embodiments, the sensors are configured to be attached to the fingers of a user.

In some embodiments, a portable music system may include means for detecting movement of a user's fingers, means for communicating a signal that a particular finger has been depressed, control module means for receiving the signal that a particular finger has been depressed and playing a sound in response to the particular finger, and/or means for securing the control module means to a user.

### DETAILED DESCRIPTION

Embodiments of the present invention comprises a musical instrument in the form of a portable keyboard-type device that may be attached to the body of a user, such as on the wrist.

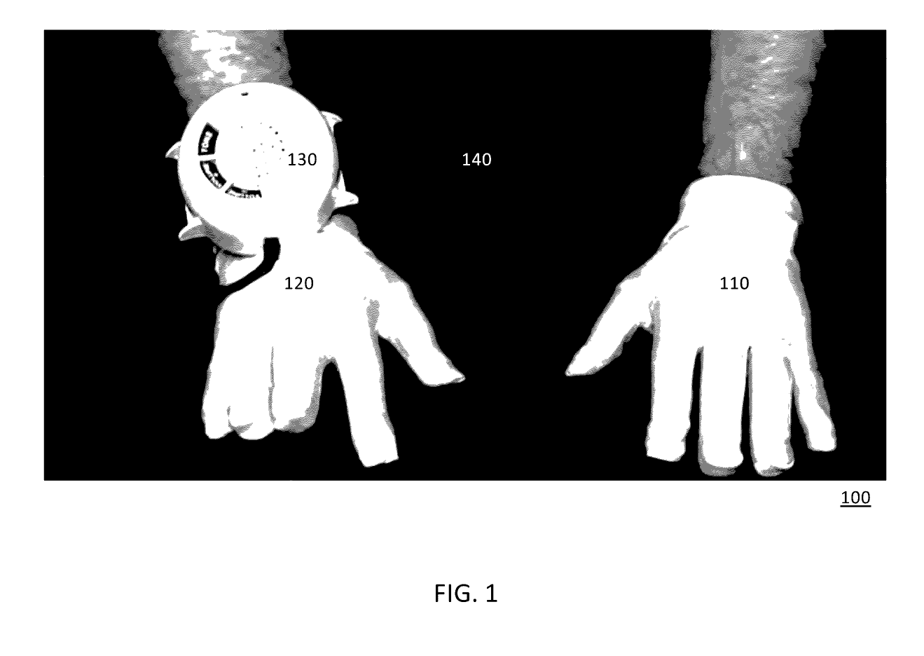

Referring to FIG. 1, an exemplary embodiment is shown. Wrist band piano 100 generally comprises left-hand and right-hand sensor gloves (110, 120), a control module 130 and a communication link 140 connecting the control module 130 with left-hand and right-hand sensor gloves (110, 120) gloves.

Left-hand and right-hand sensor gloves (110, 120) gloves may be fitted with an array of pressure sensors that communicate a signal to control module 130, via communication link 140, that a particular finger has been depressed against a contact surface. Control module 130 may then play a sound corresponding to a piano (or other musical instrument) at a frequency roughly corresponding to a physical location on the piano. In operation, the wrist band piano is a mini piano placed on wrist and can be played anytime anywhere.

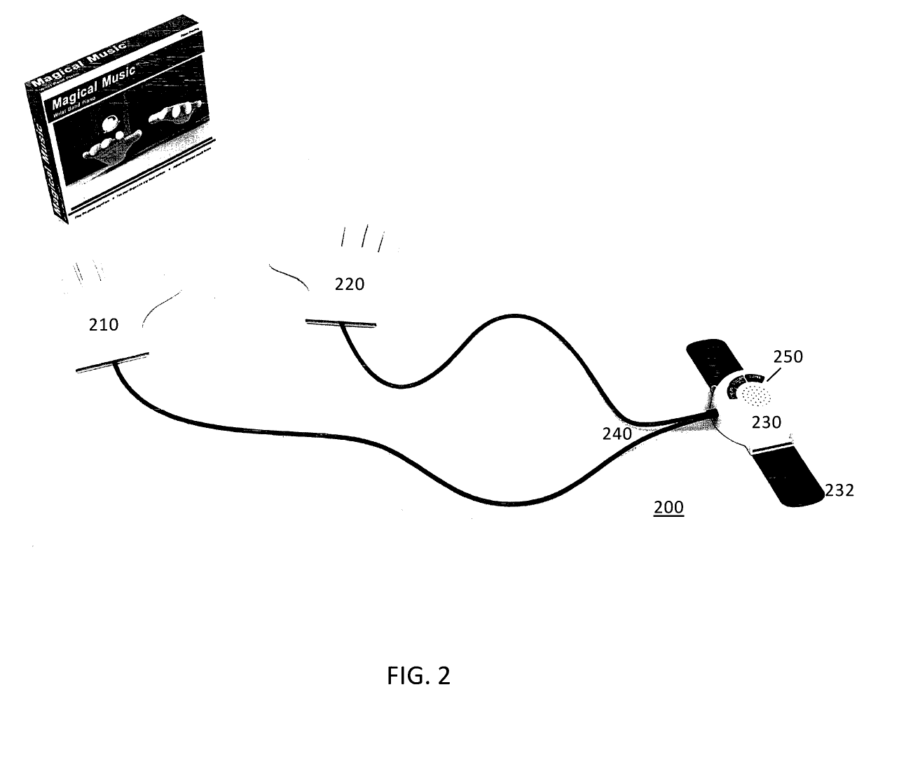

FIG. 2 is an alternate view of the embodiment shown in FIG. 1. Wrist band piano 200 is generally shown attached via a communication link 240 to left-side (210) and right-side (220) sensor gloves that have been fitted with an array of pressure sensors that communicate a signal to control module 230. A wrist strap 232 may secure the control module on the wrist or forearm of the user. Control inputs and outputs 250 may be provided on control module 230.

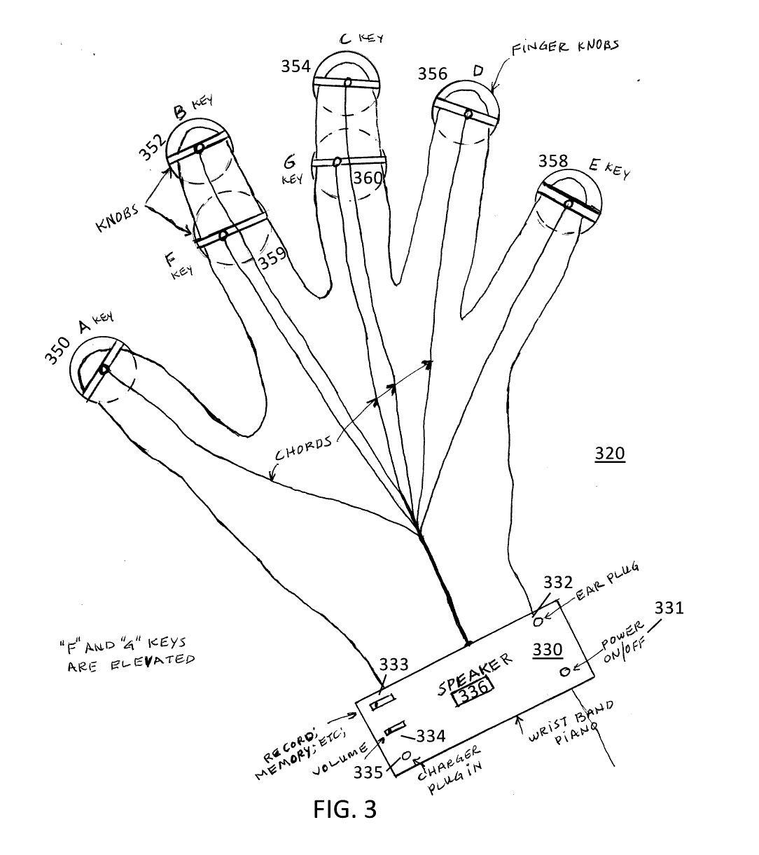

Referring to FIG. 3, a cutaway view of right-side sensor glove 320 is shown. Glove may be made from a variety of materials including, for example, natural materials such as cotton and wool, or synthetic fibers such as polyester, rayon, satin, sateen, and microfiber, or blends of any of these materials. The material selected should be sufficiently durable so as to maintain integrity under repeated use, and is preferably resistant to dirt. The gloves may incorporate aesthetic features including colors and textures in the glove materials, as well as adornments such as sequins, jewels, rhinestones, beads, and the like.

Glove material may also be able to accommodate an array of pressure-sensitive sensors 350-360 that mat be embedded in the glove and positioned at predicated contact locations. Communication link 340 may also be sewn into or integrated into the glove.

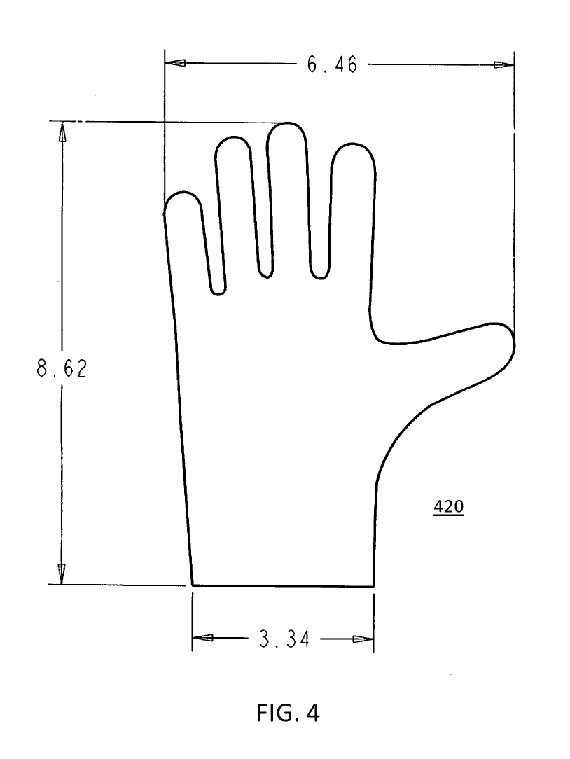

In an exemplary embodiment, a glove measuring 8.62″ in length, 6.46″ from the end of the thumb to the pinky, and 3.34″ in width at the wrist, a configuration that is shown in FIG. 4. The size of the glove may be varied significantly depending on the intended user.

The details of the sensor array 350-360 will now be described. In a preferred embodiment, sensor array 350-360 may comprise a plurality of pressure sensitive resistors with an active smaller than the average human fingertip, and a profile that is sufficiently compact so as to embed in the distal portion of the glove fingers. Typical pressure-sensitive resistors comprise a spacer sandwiched between a flexible substrate with a printed semiconductor and a second flexible substrate with printed electrodes. As pressure is applied and contact is made between the substrates, the device exhibits a decrease in resistance. The decrease in resistance may be communicated to the control module indicating that the finger has been pressed. In embodiments, the degree of force with which the finger has been pressed may also be communicated to the control module.

In embodiments, pressure sensors may be embedded in each of the five finger portions—350, 352, 354, 356, 358, 359, 360—of the sensor glove 320 corresponding to the keys of a piano, namely, A, B, C, D, and E. Additional sensors (359, 360) may be positioned along the fingers of the glove corresponding to the keys F and G. The positions of the sensors in the gloves may vary depending on the specific application and needs of the user, and may vary with the size of the system.

In alternate embodiments, finger motion may be detected and identified using an array of micro-electromechanical sensors including accelerometers, gyroscopes and compasses coupled to a microprocessor, or dedicated motion sensing Micro Electro Mechanical Systems (MEMS) devices. In still further embodiments, the pressure-sensitive sensors may be mechanical switches.

In alternate embodiments, the invention may be formed without a glove and instead utilize clips that attached the sensors to the fingers of the user. Sensors may be attached to the fingers used clips, elastic bands, rings, and the like.

Whatever the specific characteristics of the sensor array, a connection may be provided between the sensor array and control module. Communication link 340 may deliver power to each of the sensors in the array, and deliver signals from the array back to the control module 330 indicating that one of the sensors has made contact with a surface and that a tone should be played. Circuitry in the control module may then evaluate which sensor has been activated and in turn, what sound should be played.

In embodiments, communication link may simply be a cable capable of transmitting electrical signals between the gloves and control module. Alternatively, wireless transceivers (e.g., Bluetooth) may be integrated into the control module and sensor gloves obviating the need for a wired connection.

Control module 330 may form a housing for containing the power supply and electronics related to producing music tone. Control module 330 may comprise a housing generally in the shape of a contoured box that is large enough to house the electronics of the system, but also small enough to be worn on the wrist of a user, whether an adult or child.

A plurality of buttons or switches may be provided on the exterior of control module 330 that activates various functionality. For example, a switch 331 to power the device on and off may be provided, along with a 3.5 mm headphone 332 jack to deliver a line out signal to a pair of headphones or other external device. A switch to enable recording 333 may be provided, along with a volume control 334. In the case of a rechargeable power supply, a charging port 335 may be provided which, in a preferred embodiment, is configured to receive a Mini or Micro USB connector to connect the device to an external power supply. A mode selection button may also be provided to vary the sound of the device from a piano to other musical instruments such as a guitar, violin, flute, saxophone, and accordion, among others.

In alternate embodiments, a control module may be positioned adjacent to each hand with no communication link between the left and right hands.

A speaker grill 336 may also be formed in the face of the control module 330, which protects a speaker positioned in the housing and connected to the system electronics. These control options are meant to illustrate the range of functions that may be built into the control module 330 and are in no way limiting.

In embodiments where the wrist band piano is configured to simulate the keys on a piano—A, B, C, D, E, F, G, etc.—the system may play a sound corresponding to the finger (and sensor) that has been activated. In embodiments, an integrated circuit may be utilized to receive control signals from the sensor array and generate a signal to be played over the speaker or through the headphone jack.

For example, a 555 timer IC running in a stable multivibrator mode may receive signals of varying resistance from the sensor array and in turn, generate a variable frequency wave that is applied to the speaker. Such a configuration is simple to manufacture and low in cost. Alternatively, a microcontroller-based solution may be used in which a variety of recorded sounds—simulating piano keys or other instruments—are stored in a memory in a digital format. Dedicated integrated circuits capable of recording and playing sounds may also be utilized. It will be appreciated by those of ordinary skill in the art that numerous solutions are available for converting signals received from the sensor array into corresponding audio tones.

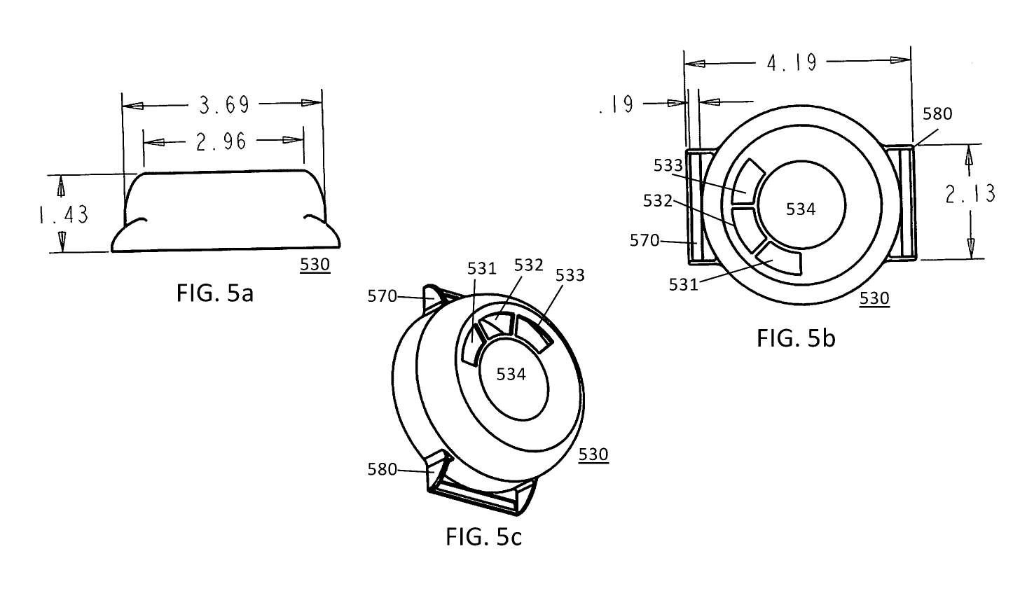

FIGS. 5a-5c show an alternate version of control module 530. Referring to FIG. 5b, recesses for control buttons 531-533 are shown adjacent speaker grill 534. Brackets 570, 580 provide support for a wrist band (not shown) to be connected to control module 530. is shown

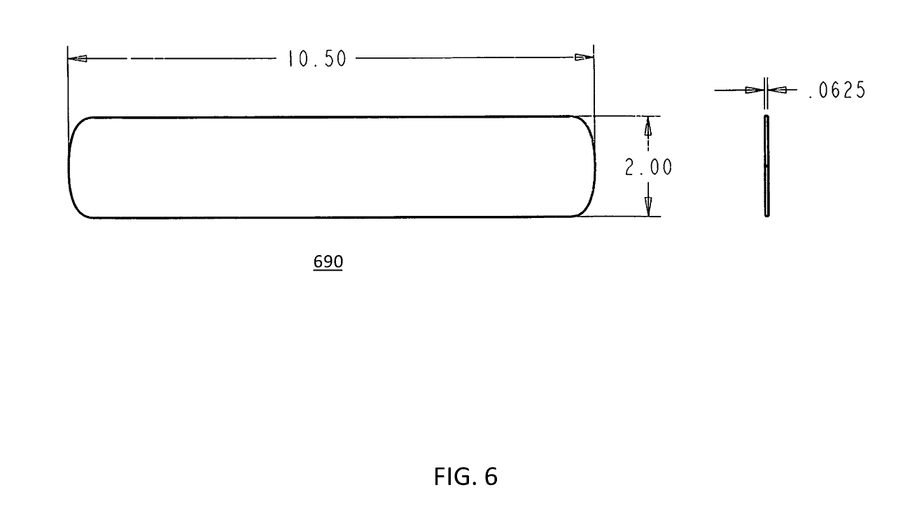

Referring to FIG. 6, an exemplary wrist band portion 690 is shown. In this example, wrist band portion 690 may be 10.50″×2.0″ with a thickness of 0.0625″. The wrist band portion is preferably made from a stretchable material with elastic properties such as silicone, nylon polyester, spandex, or a blend of any of the above or similar materials. In alternate embodiments, a strap similar to a watchband may be utilized and made from leather, rubber, various metals, or the like, with a buckle to open and close the strap.

In order to play the wrist band piano the sensors are attached to the fingers, or the hand inserted into the specialized glove, and they are pressed on anything to play the music. In embodiments, contact sensors may be responsive to touch against any surface such as, for example, the chest, stomach, thigh, desk, wall, and the like. In embodiments, contacts sensors may be receptive to not only contact, but the force imparted against the contact surface, and vary the sounds generated accordingly.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A portable music system comprising:
at least one sensor glove in which a plurality of pressure-responsive sensors have been embedded;
a control module comprising a housing, speaker, power supply, and an integrated circuit, wherein said integrated circuit is configured to receive a signal from one the pressure-responsive sensors when the sensor is depressed and play a sound;
a communication link connecting said sensor glove to said control module; and
a wrist band for securing said control module to a user.

2. The system of claim 1 wherein said pressure-responsive sensors are pressure-responsive resistors.

3. The system of claim 1 wherein said pressure-responsive sensors are pressure-mechanical switches.

4. The system of claim 1 wherein said wrist band is formed from one of: elastic material, leather, and silicone.

5. The system of claim 1 wherein said control module is capable of simulating a plurality of different musical instruments.

6. The system of claim 1 wherein said control module is further configured to record the sounds generated for later playback.

7. The system of claim 1 wherein said communication link is a wireless connection between said control module and said sensor glove.

8. A portable music system comprising:
a plurality of pressure-responsive sensors;
a control module comprising a housing, speaker, power supply, and an integrated circuit, wherein said integrated circuit is configured to receive a signal from one the pressure-responsive sensors when the sensor is depressed and play a sound;
a communication link connecting said sensors to said control module; and
a wrist band for securing said control module to the user.

9. The system of claim 8 wherein said pressure-responsive sensors are pressure-responsive resistors.

10. The system of claim 8 wherein said pressure-responsive sensors are pressure-mechanical switches.

11. The system of claim 8 wherein said wrist band is formed from one of: elastic material, leather, and silicone.

12. The system of claim 8 wherein said control module is capable of simulating a plurality of different musical instruments.

13. The system of claim 8 wherein said control module is further configured to record the sounds generated for later playback.

14. The system of claim 8 wherein said communication link is a wireless connection between said control module and said sensors.

15. The system of claim 8 wherein said sensors are configured to be attached to the fingers of a user.

16. A portable music system comprising:
means for detecting movement of a user's fingers;
means for communicating a signal that a particular finger has been depressed;
control module means for receiving the signal that a particular finger has been depressed and playing a sound in response to the particular finger being depressed; and
means for securing said control module means to a user.
